(19) United States
(12) Patent Application Publication
(10) Pub. No.: US 2002/0163953 A1
(43) Pub. Date: Nov. 7, 2002

(54) Wave-guide arrangement for infrared clinical thermometer

(75) Inventor: Chu-Yih Yu, San Chung City (TW)

Correspondence Address: DOUGHERTY & TROXELL, Suite 1404, 5205 Leesburg Pike, Falls Church, VA, 22041, US

(73) Assignee: Mesure Technology Co., Ltd.

(21) Appl. No.: 09/846,290

(22) Filed: May 2, 2001

(51) Int. Cl. G01J 5/08; G01J 5/00

(52) U.S. Cl. 374/131

(57) ABSTRACT

A wave-guide arrangement includes a conical shell, a wave-guide mounted in the conical shell, a thermopile fastened to the wave-guide and adapted to detect radiation heart, the wave-guide having an isothermic base, a front neck perpendicularly extended from and formed integral with the center of the front side of the isothermic base, a coupling portion disposed at the center of the rear side of the isothermic base and adapted to receive the thermopile, and a center wave-guide hole axially extended through the neck, the isothermic base and the coupling portion, and adapted to guide radiation heat to the thermopile.

### BACKGROUND OF THE INVENTION

The present invention relates to a clinical thermometer and, more specifically, to a wave-guide arrangement for infrared clinical thermometer.

The temperature detection head of a conventional infrared clinical thermometer is generally comprised of a wave-guide tube mounted in a conical shell, and an infrared radiation detector connected to the inner end of the wave-guide tube to detect the temperature of the radiation heat. Because there is a certain distance between the outer end of the wave-guide tube and the infrared radiation detector at the inner end of the wave-guide tube, a temperature difference exists between two distal ends of the wave-guide tube that affects the accuracy of the detection of the infrared radiation detector. In order to eliminate this problem, an isothermic block may be embedded in the wave-guide tube to minimize temperature difference between the ends of the wave-guide tube. However, because the wave-guide tube and the isothermic block are of different materials, heat conduction loss cannot be completely eliminated. Further, the use of the isothermic block greatly complicates the fabrication procedure and the manufacturing cost of the infrared clinical thermometer.

### SUMMARY OF THE INVENTION

The present invention has been accomplished under the circumstances in view. It is the main object of the present invention to provide a wave-guide arrangement for infrared clinical thermometer, which guides radiation heat efficiently to achieve accurate temperature detection. It is another object of the present invention to provide a wave-guide arrangement for infrared clinical thermometer, which greatly reduces the manufacturing cost of the infrared clinical thermometer. According to the present invention, the wave-guide is made in integrity from heat-conducting material, having an isothermic base, a front neck forwardly extended from the isothermic base and defining with the conical shell of the temperature detection head of the infrared clinical thermometer a space adapted to isolate heat, and a guide hole axially extended through the front neck and the isothermic base and adapted to guide radiation heat to a thermopile at the rear side of the isothermic base.

### BRIEF DESCRIPTION OF THE DRAWINGS

FIG. 1 illustrates an infrared clinical thermometer constructed according to the present invention.

FIG. 2 is a perspective view of a temperature detection head for infrared clinical thermometer according to the present invention.

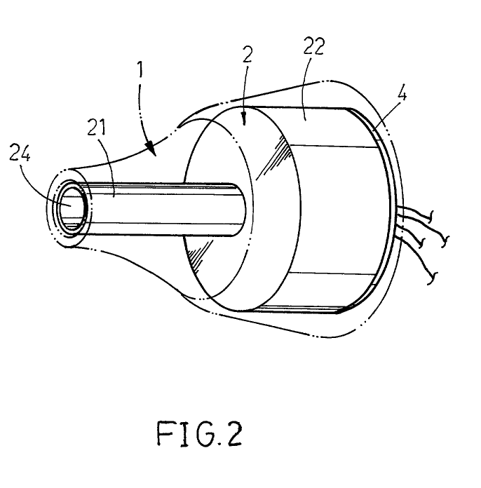

FIG. 3 is an exploded view of FIG. 2.

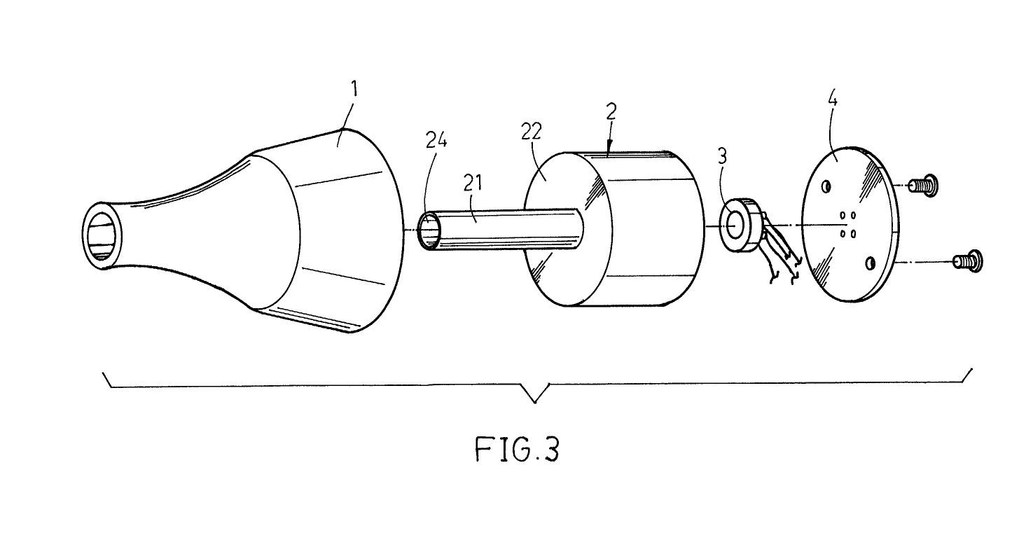

FIG. 4 is a sectional view of the temperature detection head shown in FIG. 2.

FIG. 5 shows an alternate form of the present invention.

FIG. 6 sloops another alternate form of the present invention.

FIG. 7 shows still another alternate form of the present invention.

### DETAILED DESCRIPTION OF THE PREFERRED EMBODIMENT

Referring to FIGS. from 1 through 3, a wave-guide 2 is mounted in a conical shell 1. The wave-guide 2 is made in integrity from heat-conducting material, for example, copper, aluminum, or their alloy, comprising an isothermic base 22, a front neck 21 perpendicularly extended from the center of the front side of the isothermic base 22, a coupling portion 23 disposed at the center of the back side of the isothermic base 22, and a center wave-guide hole 24 extended through the front neck 21, the isothermic base 22 and the coupling portion 23.

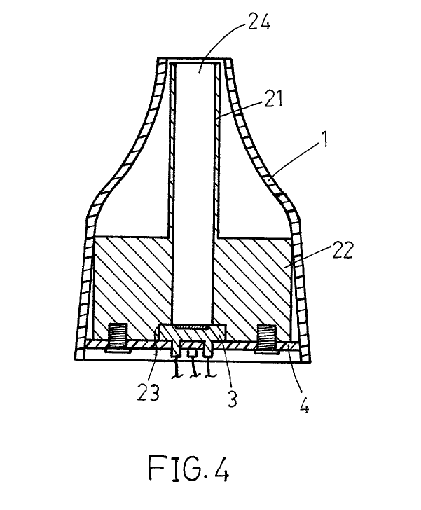

2. Referring to FIG. 4, a space is defined within the conical shell 1 around the front neck, 21 to isolate heat, so as to improve the accuracy of temperature detection of the infrared clinical thermometer. The isothermic base 22 and the front neck 21 are made from same heat-conducting material to eliminate contact conduction heat loss, so as to improve the accuracy of the temperature detection of the infrared clinical thermometer. The coupling portion 23 is adapted to receive a thermopile 3. The coupling portion 23 according to the present preferred embodiment is a recessed hole formed on the rear side of the isothermic base 22 at the center and fitting the shape of the thermopile 3. The thermopile 3 is a sensible radiation detector adapted to detect radiation heat. Infrared radiation heat passes through the center wave-guide hole 24 of the wave-guide 2 toward the thermopile 3, enabling the thermopile 3 to accurately detect the temperature of the infrared radiation. A cover member 4 is fastened to the isothermic base 22 to fix the thermopile 3 to the coupling portion 23. The cover member 4 can be a PCB (printed circuit board) or cover plate fixedly fastened to the isothermic base 22 by screws.

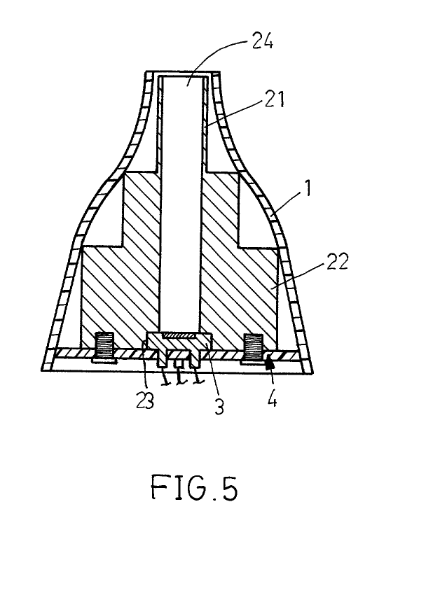

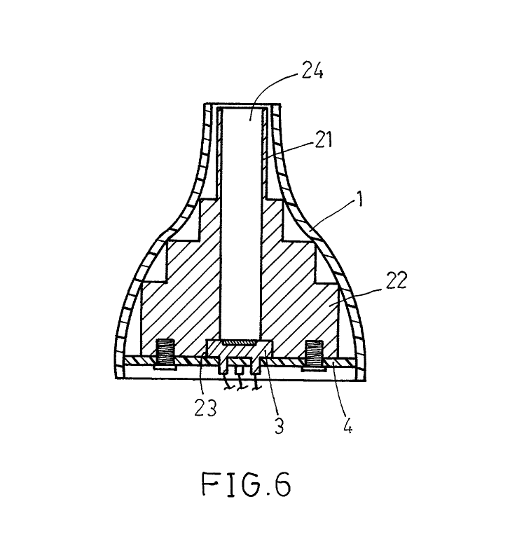

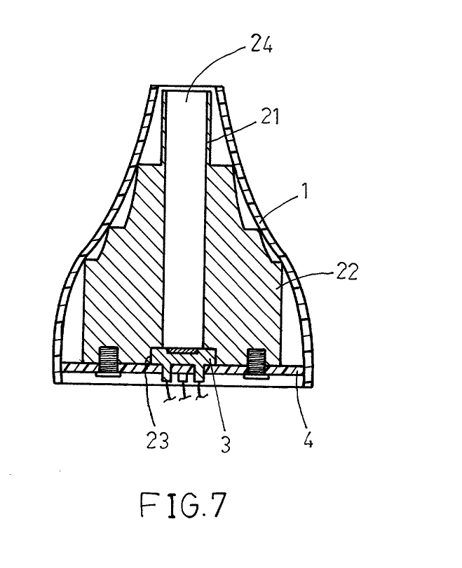

Referring to FIGS. from 5 through 7, the isothermic base 22 can be made having a stepped profile (see FIG. 5), double-stepped profile (see FIG. 6), multi-stepped profile with curved periphery (see FIG. 7), or any of a variety of profiles that define with the inside wall of the shell 1 a space to isolate heat..

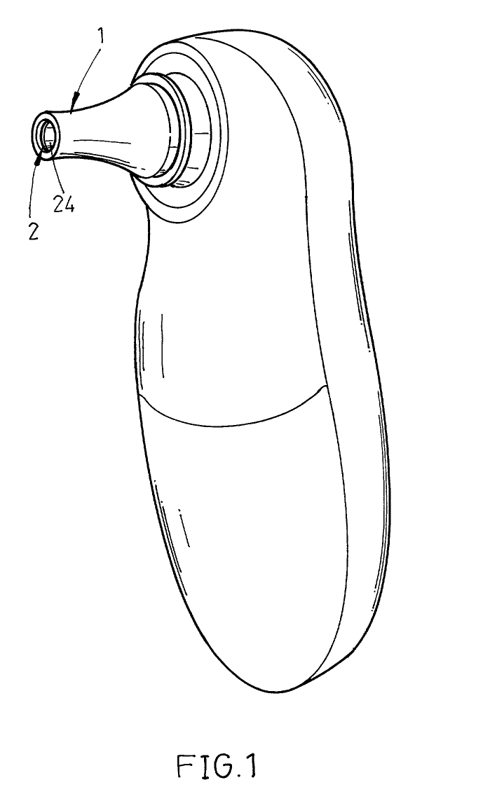

A prototype of wave-guide arrangement for infrared clinical thermometer has been constructed with the features of FIGS. 1˜7. The wave-guide arrangement for infrared clinical thermometer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A wave-guide arrangement comprising a conical shell, a wave-guide mounted in said conical shell, a thermopile fastened to one side of said wave-guide and adapted to detect radiation heat, wherein said wave-guide comprises an isothermic base having a front side and a rear side, a front neck perpendicularly extended from the center of the front side of said isothermic base and defining with said conical shell a space adapted to isolate heat, a coupling portion disposed at the center of the rear side of said isothermic base and adapted to receive said thermopile, and a center wave-guide hole adapted to guide radiation heat to said thermopile.

2. The wave-guide arrangement of claim 1 wherein said wave-guide hole extends axially through said front neck, said isothermic base, and said coupling portion.

3. The an wave-guide arrangement of claim 1 wherein said coupling portion is a recessed hole formed on the rear side of said isothermic base at the center and fitting the shape of said thermopile.
